(19) United States
(12) Patent Application Publication
(10) Pub. No.: US 2025/0121315 A1
(43) Pub. Date: Apr. 17, 2025

(54) FACILITY FOR RECOVERING CO2 FROM A FEED GAS FLOW

(71) Applicant: L'Air Liquide, Societe Anonyme pour l'Etude et l’Exploitation des Procedes Georges Claude, Paris (FR)

(72) Inventors: Jian-Wei CAO, Hangzhou (CN); Guillaume RODRIGUES, Champigny Sur Marne (FR); Martin RAVENTOS, Champigny Sur Marne (FR); Richard DUBETTIER, Champigny Sur Marne (FR); Mathieu LECLERC, Champigny Sur Marne (FR)

(73) Assignee: L'Air Liquide, Societe Anonyme pour l'Etude et l’Exploitation des Procedes Georges Claude, Paris (FR)

(21) Appl. No.: 18/730,430

(22) PCT Filed: Jan. 19, 2023
(86) PCT No.: PCT/EP2023/051275

§ 371 Date: Jul. 19, 2024

(30) Foreign Application Priority Data
Jan. 21, 2022 (FR) FR2200530

(51) Int. Cl. B01D 51/10; B01D 53/047; F25J 3/02

(52) U.S. Cl. CPC B01D 51/10; B01D 53/047; F25J 3/0266; B01D 2256/22; B01D 2257/102; B01D 2258/0283; B01D 2259/40001; B01D 2259/65; F25J 2210/70; F25J 2220/84; F25J 2230/04; F25J 2230/20; F25J 2230/30; F25J 2240/12; F25J 2240/90; F25J 2260/02; F25J 2260/44

(57) ABSTRACT

A facility for recovering carbon dioxide from a feed gas flow, including a unit for treating the feed gas flow in order to produce, from feed gas flow, a carbon dioxide-rich gas flow and a nitrogen-rich gas flow, a compression stage for compressing the feed gas flow, an expansion stage capable of outputting mechanical energy generated by the expansion of the nitrogen-rich gas flow, a thermal device arranged to enable heat transfers to take place between the gas flow leaving the compression stage and the nitrogen-rich gas flow prior to expansion, and a device for utilising the mechanical energy output by the expansion stage.

### CROSS-REFERENCE TO RELATED APPLICATIONS

This application is a § 371 of International PCT Application PCT/EP2023/051275, filed Jan. 19, 2023, which claims § 119(a) foreign priority to French patent application FR 2200530, filed Jan. 21, 2022.

### BACKGROUND

The present invention relates to a facility for recovering CO2 from a feed gas flow which is in particular a combustion flue gas.

### FIELD OF THE INVENTION

Hydrogen is an energy carrier that plays an increasing role in the decarbonisation of various sectors, in particular transport and industry. Hydrogen can be produced from the reforming reaction of natural gas (in SMR [Steam Methane Reforming] furnaces). In SMR units, hydrogen production is accompanied by significant CO2 production. A unit for capturing CO2 of the PSA type (which is a Pressure Swing Adsorption device) can be added to an SMR in order to reduce the carbon footprint of hydrogen production by SMR. CO2 capture (e.g. CO2 treatment and liquefaction for food use or for sequestration) can be carried out cryogenically or non-cryogenically, for example, amine scrubbing. A gas flow rich in nitrogen at high pressure is produced on this occasion in the PSA unit.

The invention proposes improving the energy efficiency of the facility.

### SUMMARY OF THE INVENTION

One subject of the invention is thus a facility for recovering CO2 from a feed gas flow which is in particular a combustion flue gas, this facility comprising:
a unit for treating the feed gas flow by pressure swing adsorption so as to produce, from the feed gas flow, a gas flow rich in CO2 and a gas flow rich in nitrogen,
a compression assembly comprising at least one compression stage for compressing the feed gas flow before it enters the treatment unit,
a turbine comprising at least one expansion stage capable of delivering mechanical energy generated by the expansion of the gas flow rich in nitrogen in this expansion stage,
a thermal device arranged so as to allow transfers of heat between the feed gas flow exiting a compression stage and the gas flow rich in nitrogen before expansion in the expansion stage, so as to heat the gas flow rich in nitrogen prior to its expansion,
a device for utilizing the mechanical energy delivered by the expansion stage.

The feed gas flow, upstream of the compression assembly, may, by way of example, contain from 10 to 60 mol % of CO2, in particular from 15 to 50 mol % of CO2. The remainder is mostly nitrogen and small quantities of O2. Argon Ar may potentially be present with an order of magnitude of 1 mol % or less, as well as traces of impurities, in particular of NOx.

The feed gas flow may originate from an SMR reformer, a cement works, an oxycombustion unit, or a lime factory for example.

The feed gas flow may have been subjected to a pretreatment before entering the facility, for example through a scrubbing unit or a filtration unit.

The gas flow rich in nitrogen exiting the PSA unit at high pressure may contain, in addition to nitrogen, the least adsorbable constituents such as, where applicable, O2, Ar, NO.

The percentage of nitrogen in the flow rich in nitrogen is in particular between 50 and 90 vol %.

CO2 represents a portion, for example from 50 to 85 vol %, in the gas flow rich in CO2.

In general, the compositions are given on a dry basis, that is to say the water (H2O) is removed from the composition of the gas and the remaining constituents are standardized to 100.

According to one of the aspects of the invention, the feed gas flow arrives at the treatment unit, after having been compressed in the compression assembly, at a pressure within a range of 3 to 15 bar abs, in particular of 6 to 12 bar abs, in particular 8 to 10 bar abs, and at a temperature close to ambient, for example between 5 and 45° C.

According to one of the aspects of the invention, the gas flow rich in nitrogen is discharged from the treatment unit at high pressure, in particular at a pressure of between 8 and 10 bar.

According to one of the aspects of the invention, the compression assembly comprises a centrifugal compressor in which the feed gas flow can be accelerated through one or more wheels set in rotation by a motor, in particular an electric motor. The energy thus acquired by the gas flow is transformed into an increase in its static pressure in a diffuser situated at the outlet of each of the wheels. The arrangement of the wheels of the compression assembly depends on characteristics of the method, for example the flow rate, the compression rate, the composition of the gas, but also the technology specific to the different compressor manufacturers.

In general, the motor drives a main rotational axle associated with a main gear and possibly an auxiliary gear. These gears are mechanically connected to pinions coupled to secondary rotational axles. Each gear can thus drive several pinions. The respective dimensions of the gear and of the pinion determine the rotational speed of the secondary axle as a function of the rotational speed of the motor.

If there is a single compression stage, the secondary axle drives the single wheel for compressing the gas flow to the selected pressure.

When the compression assembly comprises several wheels for implementing the overall compression rate selected, that is to say the ratio of the outlet pressure to the inlet pressure in the compression assembly, there are different arrangements possible for these wheels.

It is also noted that, if the compression is effected in several stages, a compression rate per stage, that is to say the ratio of the outlet pressure of the stage in question to its inlet pressure, is defined.

It is also noted that, in this case, it is possible to partially adjust the respective compression rates of the different stages in order to obtain the overall compression rate, and to do so while remaining within the limits of the possible dimensions, in particular while respecting the admissible maximum speeds and temperatures. This flexibility can make it possible to more easily incorporate the various compression wheels in the compression assembly.

The invention provides for the compression assembly to be associated with one or more wheels of an expansion turbine in order to recover the mechanical energy produced by the expansion of the gas flow rich in nitrogen, thus making it possible to reduce the energy that has to be provided by the motor.

In the present invention, the turbine, also called expansion turbine, is an item of equipment making it possible to expand a fluid from its high pressure to its low pressure, the ratio of these pressures being called expansion rate.

A turbine comprises one or more expansion stages, the number of expansion stages being dependent on the operating conditions, in particular the expansion rate.

If the expansion is effected in several stages, an expansion rate per stage, that is to say in this case the ratio of inlet pressure to outlet pressure of the stage in question, is also defined.

The expansion of the gas is very generally effected through one or more wheels set in rotation by the gas and decelerated by a brake. In practice, the turbine may then comprise several wheels in series in relation to the gas flow, each of the wheels being able to have its own geometry and its own rotational speed.

According to one of the aspects of the invention, the utilization device is an electric generator capable of utilizing the mechanical energy delivered by the expansion stage so as to produce electricity.

This electric generator makes it possible to utilize the energy of expansion by producing electricity which can be used locally or via an electrical grid.

In a variant, the utilization device comprises the compression stage which is arranged so as to receive the mechanical energy delivered by the expansion stage.

In this case, the invention can make it possible to transmit the energy supplied by the turbine directly in mechanical form to the compression assembly of the facility.

Indeed, from an economic point of view, it generally proves to be more advantageous to modify a compressor through addition of expansion wheels than to install an electric generator.

It will be noted that, in this type of expansion, the expanded gas is cooled down greatly and this can generate a risk of condensation in the wheel or at the outlet, leading to problems of erosion, or even problems of corrosion in the presence of constituents such as NOx.

Heating the gas flow rich in nitrogen before expansion makes it possible both to increase the recoverable energy and to avoid excessively low temperatures at the outlet of the expansion wheel or wheels.

If there are several expansion stages, it is possible to adjust the expansion rates of each stage in order to obtain the overall expansion rate, and to do so while remaining within the limits of the possible dimensions, in particular while respecting the admissible maximum peripheral speed. This flexibility can make it possible to more easily add the expansion wheels in the compression assembly.

An expansion wheel of the turbine can have different positions:
either on the same axle as a compression stage, preferably arranged on the other side of a pinion. It will be noted that, in this case, wheel of the turbine and wheel of the compressor rotate at the same speed. Nevertheless, the internal speeds of the gas in the wheels, in particular the peripheral speeds, will be dependent on the geometry of each of the wheels.
or on a second axle still in mechanical connection with a main gear but via a second pinion. In this case, the rotational speed of the wheel of the turbine is independent of the rotational speed of the compression wheel and is dependent only on the respective diameters of the main gear and of the second pinion. It will be noted that the main gear can be in mechanical connection with several pinions of different diameter thus setting several axles in rotation, each at a selected speed.
or on another axle in mechanical connection with the secondary gear via another pinion. The speed of the expansion wheel is then adaptable.
or possibly on an axle comprising a secondary pinion in mechanical connection with the pinion driving a compression stage. Here, too, the speed of the expansion wheel is adaptable according to the selection of the diameter of the secondary pinion. In this case, the compression stage receives a torque both from the motor and from the expansion wheel.

It can be seen that, according to the selected configuration, the energy produced by the expansion of the gas flow rich in nitrogen is transmitted directly to the rotational axle of the compression stage or to the main axle of the motor, so as to supply the energy from the expansion to the compression assembly.

The secondary gear can be arranged in any way on the axle of the motor, that is to say on the same side with respect to the motor as the main gear or on the other side of the motor on an extension of the axle. It can be situated between the motor and the main gear or after the main gear for example.

Two wheels of the turbine may possibly be on the same axle and be mechanically connected to the motor axle via a pinion in contact with the main gear or with the secondary gear or to the axle of a compression wheel.

As above, the energy of the expansion is provided directly to the rotational axle of the compression wheel or to the axle of the motor. Thus the energy released by the expansions is supplied to the compression assembly.

If the facility comprises at least two compression stages in the compression assembly and a turbine comprising at least two expansion stages actuatable by the gas flow rich in nitrogen, the compression and expansion rates, respectively, of at least one of the compression stages and of at least one expansion stage are selected such that the compression wheel of the compression stage and the expansion wheel of the expansion stage have the same rotational speed and are mounted on the same axle.

If the facility comprises a turbine comprising at least two expansion stages actuatable by the gas flow rich in nitrogen, the respective expansion rates of the two expansion stages are selected such that the corresponding wheels have the same rotational speed and are mounted on the same axle.

In the invention, in the expansion stage or stages of the turbine, an expansion from a high pressure to a lower pressure of the gas flow rich in nitrogen occurs, which expansion has the effect of setting for example a wheel of the turbine in rotation which is braked by the utilization device, which is for example the compression assembly. The invention thus makes it possible to improve the efficiency of the facility due to the recovery of mechanical energy from the gas flow rich in nitrogen, this flow being at high pressure and making it possible to actuate the expansion stage or stages of the turbine. The efficiency is improved significantly with respect to the case in which the pressurized flow of nitrogen would simply be discarded into the atmosphere, without being subject to a recovery of energy.

In the invention, the flow of nitrogen, once the expansion has been performed, is discharged into the atmosphere.

According to one of the aspects of the invention, the number of expansion stages of the turbine is adjusted depending on needs.

According to one of the aspects of the invention, the expansion stage of the turbine and the compression stage each comprise a rotary shaft and their shafts are connected such that a rotation of the shaft of the expansion stage of the turbine supplies a torque to the shaft of the compression stage.

According to one of the aspects of the invention, the facility comprises at least two compression stages in the compression assembly and a turbine comprising at least two expansion stages actuatable by the gas flow rich in nitrogen, each expansion stage of the turbine being arranged so as to transmit mechanical energy to the compression assembly, in particular irrespective of whether this is directly to one of the compression stages or to a rotational shaft common to several compression stages or to a shaft of a motor which actuates the compression stages.

According to one of the aspects of the invention, the facility comprises at least two compression stages in the compression assembly and at least two expansion stages in which the gas flow rich in nitrogen expands, these expansion stages being arranged so as to deliver mechanical energy to the compression stages.

According to one of the aspects of the invention, these expansion stages are arranged in series in such a way that the gas flow rich in nitrogen first passes through one of the expansion stages and then the other.

According to one of the aspects of the invention, each expansion stage is arranged so as to transmit mechanical energy to one of the compression stages.

According to one of the aspects of the invention, the expansion stage or stages transforming the energy of the gas flow rich in nitrogen may be dimensioned so as to provide at least 25%, in particular around 40% or 50%, of the mechanical energy required for operating the compression stages.

The invention is thus particularly advantageous because it makes it possible to recycle energy and reduce the consumption of external energy at the facility.

As they pass through the thermal device, the gas flow rich in nitrogen, before expansion in the expansion stage, is for example at an ambient temperature, and the feed gas flow exiting a compression stage is at a higher temperature.

The invention thus makes it possible to take advantage of the gas flow rich in nitrogen, which is substantially at ambient temperature at the outlet of the PSA unit, in order to cool the feed gas flow and heat the gas flow rich in nitrogen so as to improve the overall thermodynamic performance of the facility. Advantageously, the nitrogen cools the feed gas flow before compression, rendering this compression more efficient (since the volume to be compressed is lower, the compression energy is lower), and, at the same time, the feed gas flow heats the nitrogen before expansion, increasing the recoverable energy.

According to one of the aspects of the invention, the thermal device comprises at least one gas/gas heat exchanger arranged so as to allow transfers of heat between the feed gas flow exiting a compression stage and the gas flow rich in nitrogen before expansion in the expansion stage, so as to heat the gas flow rich in nitrogen prior to its expansion.

The invention makes it possible to avoid the flow rich in nitrogen being at an excessively low temperature.

According to one of the aspects of the invention, the gas/gas heat exchanger is arranged at the outlet of the compression stage such that the feed gas flow first passes through the compression stage before passing through the heat exchanger.

The gas/gas heat exchanger thus makes it possible to cool the feed gas flow which has undergone an increase in temperature due to the compression in the compression stage.

According to one of the aspects of the invention, the thermal device comprises at least two gas/gas heat exchangers for exchanging heat between the gas flow rich in nitrogen and the feed gas flow, each gas/gas heat exchanger being positioned at the outlet of a compression stage.

According to one of the aspects of the invention, the two gas/gas heat exchangers are arranged in series for the gas flow rich in nitrogen such that this gas flow rich in nitrogen first passes through one of these gas/gas heat exchangers and then through the other of the gas/gas heat exchangers.

According to one of the aspects of the invention, an expansion stage of the turbine is provided downstream of each gas/gas heat exchanger such that the gas flow rich in nitrogen first passes through the gas/gas heat exchanger and then through the expansion stage which is used to transmit mechanical torque to the device for utilizing the mechanical energy.

According to one of the aspects of the invention, the exchangers used, which are of the gas/gas type or of the gas/heat transfer fluid type, are tubular exchangers with grille.

Depending on the flow rates, pressures and temperatures, these exchangers may also be plate exchangers.

According to one of the aspects of the invention, the gas flow rich in nitrogen passes through the same exchanger several times, for example a first time before expansion in the first expansion stage and then, on exiting this expansion stage, a second time in the same exchanger before a second expansion in the second expansion stage is affected. In this case, the exchanger is equivalent to two exchangers in parallel in relation to the heat transfer fluid.

Such configurations of exchangers in parallel are described below, in connection with examples of implementation of the invention.

According to one of the aspects of the invention, the heat exchanges in the gas/gas exchangers are effected by means of pairs of heat regenerators, one of the regenerators of the pair collecting heat from the compressed feed gas flow while cooling it and the other returning this heat to the gas flow rich in nitrogen while being cooled by this flow. The use of such a pair of heat regenerators, in place of a gas/gas heat exchanger, forms part of the invention.

According to one of the aspects of the invention, the thermal device comprises one or more gas/heat transfer fluid heat exchangers for exchanging heat between the feed gas flow and a heat transfer fluid other than the gas flow rich in nitrogen, this fluid being, for example, glycol water belonging to a cooling circuit.

According to one of the aspects of the invention, the compression assembly comprises several compression stages, one or more gas/gas heat exchangers for exchanging heat between the gas flow rich in nitrogen and the feed gas flow and one or more gas/heat transfer fluid heat exchangers for exchanging heat between the feed gas flow and a cooling fluid other than the gas flow rich in nitrogen, each heat exchanger being arranged at the outlet of one of the compression stages such that the feed gas flow first passes through the compression stage before passing through the heat exchanger.

According to one of the aspects of the invention, all of the compression stages are followed by a heat exchanger, either of the gas/gas type or of the gas/heat transfer fluid type.

In a variant, at least one of the compression stages is connected directly to the following compression stage, without any heat exchanger between these two compression stages.

According to one of the aspects of the invention, the compression assembly comprises four compression stages, two stages each being followed by a gas/gas heat exchanger and two stages each being followed by a gas/heat transfer fluid heat exchanger.

According to one of the aspects of the invention, in the circulation direction of the feed gas flow, the two first stages are each followed by a gas/heat transfer fluid heat exchanger and the two last stages are each followed by a gas/gas heat exchanger.

Thus the gas flow rich in nitrogen serves to cool the feed gas flow at the outlet of two compression stages.

According to one of the aspects of the invention, the turbine comprises two expansion stages and one of the expansion stages is positioned downstream of one of the gas/gas heat exchangers and the other of the expansion stages is positioned downstream of the other of the gas/gas heat exchangers.

According to one of the aspects of the invention, the expansion stages and the gas/gas heat exchangers are thus in series such that the gas flow rich in nitrogen passes successively through one of the gas/gas heat exchangers, then one of the expansion stages, then the other gas/gas heat exchanger and lastly the other expansion stage.

According to one of the aspects of the invention, the gas flow rich in nitrogen is substantially at atmospheric pressure when it exits the last expansion stage, and preferably at a temperature greater than −10° C., more preferably greater than 0° C. Such a temperature could be achieved by sufficiently heating the gas flow rich in nitrogen and possibly by limiting the expansion rate of the turbine, for example with a valve positioned on the circuit of the gas flow rich in nitrogen, preferably at the outlet of the last expansion stage.

This makes it possible to avoid expensive materials, to avoid or minimize the thermal insulation equipment and to make ice-cold water.

Lastly, the gas flow rich in nitrogen can be used for additional heat exchanges before being discharged into the atmosphere.

According to one of the aspects of the invention, one or more gas/heat transfer fluid heat exchangers may be provided downstream of the last gas/gas exchanger, so as to further cool the feed gas flow before it reaches the PSA treatment unit.

According to one of the aspects of the invention, a single gas/gas heat exchanger is provided in the facility, this exchanger being positioned downstream of one of the compression stages.

Two expansion stages are arranged in series downstream of this heat exchanger such that the gas flow rich in nitrogen first passes through the gas/gas heat exchanger and then successively through the two expansion stages.

This may be advantageous if the expansion rate of the turbine from the high pressure to the low pressure is relatively low but still too high to be effected in a single expansion stage. It is thus preferable to heat the inlet into the turbine to the maximum rather than providing two exchangers.

According to one of the aspects of the invention, one of the compression stages is connected directly to the following compression stage, for example the third compression stage is connected directly to a fourth compression stage, without any heat exchanger between these two compression stages.

According to one of the aspects of the invention, the facility comprises, for the gas flow rich in nitrogen, successively from the outlet of the treatment unit:
a first gas/gas heat exchanger,
a first expansion stage,
a second gas/gas heat exchanger,
a second expansion stage,
these first and second heat exchangers being positioned, for the feed gas flow, in parallel with one another and downstream of a compression stage, in particular the first compression stage.

Thus, in this example, the gas flow rich in nitrogen is used to cool the feed gas flow in the two exchangers positioned in parallel, at the outlet of the first compression stage.

According to one of the aspects of the invention, the feed gas flows subdivided into the two exchangers in parallel merge at the outlet of these two exchangers so as to reform a single feed gas flow which passes through a gas/heat transfer fluid exchanger.

As can be seen, the feed gas flow sees two gas/gas exchangers as being in parallel, whilst the gas flow rich in nitrogen sees these two gas/gas exchangers as being in series.

According to one of the aspects of the invention, the facility comprises an intermediate thermal circuit using an intermediate heat transfer fluid different from the gas flow rich in nitrogen and from the feed gas flow, this intermediate circuit being arranged so as to allow heat exchanges between the gas flow rich in nitrogen and the feed gas flow by way of the intermediate heat transfer fluid.

According to one of the aspects of the invention, if there is a plurality of compression stages, the gas flow rich in nitrogen is heated directly by a gas/gas exchanger, or indirectly by a gas/heat transfer fluid exchanger, by way of a heat transfer fluid, by withdrawing heat from feed gas flows exiting the compression stage having the highest temperature, preferably greater than 100° C., more preferably greater than 120° C., this temperature having been obtained by ensuring that the compression stage in question has a higher compression rate than the other stages or a higher inlet temperature.

According to one of the aspects of the invention, if there is a plurality of compression stages, the gas flow rich in nitrogen is heated directly by a gas/gas exchanger, or indirectly by a gas/heat transfer fluid exchanger, by way of a heat transfer fluid, by withdrawing heat from feed gas flows exiting the compression stage having the highest temperature, preferably greater than 100° C., more preferably greater than 120° C., this temperature having been obtained by ensuring that the compression stage in question has a higher compression rate than the average of the compression rates and/or a higher inlet temperature than the average of the inlet temperatures.

According to one of the aspects of the invention, this highest temperature level is used at least twice to heat the gas flow rich in nitrogen before it enters at least two expansion stages.

The invention thus makes it possible to take advantage of the highest temperature level of the feed gas flow to maximally heat the gas flow rich in nitrogen before each expansion stage.

Where appropriate, the gas flow rich in nitrogen heated by the feed gas flow via a gas/gas exchanger may be heated beforehand by one or more, in particular gas/heat transfer fluid, exchangers so as to effect the first part of the heating and take maximum advantage of the highest temperature level.

According to one of the aspects of the invention, this intermediate circuit comprises a pump for circulating the intermediate fluid.

Conventionally, the facility can comprise instrumentation (temperature sensors, pressure sensors, vibration sensors, analyzers, etc.), fittings (all or nothing valves, regulating valves, etc.) and auxiliary equipment (filters, valves, bypasses, etc.).

According to one of the aspects of the invention, the intermediate circuit is arranged such that the intermediate heat transfer fluid passes through at least one gas/heat transfer fluid heat exchanger so as to allow an exchange of heat between the heat transfer fluid and the feed gas flow and another gas/heat transfer fluid heat exchanger so as to allow an exchange of heat between the heat transfer fluid and the gas flow rich in nitrogen, said gas/heat transfer fluid exchanger being positioned upstream of an expansion stage such that the gas flow rich in nitrogen passes through this exchanger so as to be heated by the intermediate heat transfer fluid before undergoing expansion in the expansion stage.

According to one of the aspects of the invention, the gas/heat transfer fluid heat exchanger for allowing an exchange of heat between the heat transfer fluid and the feed gas flow is positioned downstream of the first compression stage such that the feed gas flow is cooled by the intermediate fluid at the outlet of this first compression stage.

According to one of the aspects of the invention, the intermediate circuit is arranged so as to pass through two gas/heat transfer fluid heat exchangers for allowing an exchange of heat between the heat transfer fluid and the gas flow rich in nitrogen, these exchangers each being positioned upstream of an expansion stage.

According to one of the aspects of the invention, these two gas/heat transfer fluid heat exchangers for allowing an exchange of heat between the heat transfer fluid and the gas flow rich in nitrogen are positioned in parallel for the intermediate heat transfer fluid such that this intermediate fluid is subdivided into two streams each passing through one of these exchangers.

According to one of the aspects of the invention, the gas flow rich in nitrogen sees, for its part, an arrangement in series of the gas/heat transfer fluid heat exchangers and the two expansion stages.

According to one of the aspects of the invention, the gas flow rich in nitrogen produced from the wet feed gas flow is dried before expansion in the expansion stage, so as to contain less than 50 ppm of H2O, preferably less than 5 ppm of H2O.

A further subject of the invention is a method for recovering CO2 from a feed gas flow which is in particular a combustion flue gas, this method comprising the following steps:
compressing, using a compression stage, the feed gas flow,
treating, using a treatment unit, the previously compressed feed gas flow by pressure swing adsorption so as to produce, from the feed gas flow, a gas flow rich in CO2 at low pressure and a gas flow rich in nitrogen at high pressure,
using a turbine comprising at least one expansion stage capable of delivering mechanical energy generated by the expansion of the gas flow rich in nitrogen in this expansion stage,
allowing transfers of heat between the feed gas flow exiting the compression stage and the gas flow rich in nitrogen before expansion in the expansion stage, so as to heat the gas flow rich in nitrogen prior to its expansion,
utilizing the mechanical energy delivered by the expansion stage, either to actuate the compression assembly or to produce electricity using an electric generator.

According to one of the aspects of the invention, the fraction of the heat energy of compression is recovered by the gas flow rich in nitrogen by means of direct heat exchange with the feed gas flow at the outlet of at least one compression stage and/or by means of indirect heat exchange via a heat transfer fluid.

According to one of the aspects of the invention, the gas flow rich in nitrogen is heated before being expanded through each of the expansion stages of the turbine.

According to one of the aspects of the invention, a torque transmission device is implemented between the respective shafts of the expansion stage or stages of the turbine and of the compression stage or stages, this torque transmission device in particular comprising gears and pinions for transmitting a torque from the turbine to the compression assembly.

According to one of the aspects of the invention, the feed gas flow is wet and contains more than 10 ppm of NOx, the gas flow rich in nitrogen is dried before expansion so as to contain less than 50 ppm of H2O, preferably less than 5 ppm of H2O.

This makes it possible to avoid any possibility of condensation during the cooling caused by the expansion, and any formation of nitric acid.

According to one of the aspects of the invention, the drying of the gas flow rich in nitrogen is effected in the unit for treating the feed gas by means of a hydrophilic adsorbent.

The invention can make it possible to take advantage of the fact that the nitrogen is dry in order to make ice-cold water.

The gas rich in CO2 coming from the PSA unit can, where appropriate, undergo additional treatments, including, for example, complementary enrichment in CO2. The residual nitrogen thus extracted from the gas rich in CO2 can be recycled and participate in the expansion and in the recovery of energy.

### BRIEF DESCRIPTION OF THE FIGURES

The invention will be understood better from reading the following description and from studying the accompanying figures. These figures are given only by way of illustration and do not in any way limit the invention.

FIG. 1 is a schematic and partial representation of a facility according to a first example of the invention;

FIG. 2 is a schematic and partial representation of a facility according to a second example of the invention;

FIG. 3 is a schematic and partial representation of a facility according to a third example of the invention;

FIG. 4 is a schematic and partial representation of a facility according to a fourth example of the invention;

FIG. 5 is a schematic and partial representation of a facility according to a fifth example of the invention.

### DETAILED DESCRIPTION OF THE INVENTION

FIG. 1 shows a facility 1 for recovering CO2 from a feed gas flow FG which is, in the example described, a combustion flue gas, this facility comprising:
a unit 2 for treating the feed gas flow FG by pressure swing adsorption (the unit 2 being a PSA unit) so as to produce, from the feed gas flow, a gas flow rich in CO2, called FCO2, and a gas flow rich in nitrogen, called FN,
a compression assembly 3 comprising at least one compression stage 5 for compressing the feed gas flow FG before it enters the treatment unit 2, a turbine 6 comprising at least one expansion stage 8 capable of delivering mechanical energy generated by the expansion of the gas flow rich in nitrogen FN in this expansion stage 8,
a thermal device 10 arranged so as to allow transfers of heat between the feed gas flow FG exiting a compression stage 5 and the gas flow rich in nitrogen FN before expansion in the expansion stage 8, so as to heat the gas flow rich in nitrogen FN prior to its expansion,
a device 4 for utilizing the mechanical energy delivered by the expansion stage 8.

The feed gas flow FG, upstream of the compression assembly 3, may, by way of example, contain from 10 to 60 mol % of CO2, in particular from 15 to 50 mol % of CO2. The remainder is mostly nitrogen and small quantities of O2. Argon Ar may potentially be present with an order of magnitude of 1 mol % or less, as well as traces of impurities, in particular of NOx.

The feed gas flow FG may originate from an SMR reformer, a cement works, an oxycombustion unit, or a lime factory.

The feed gas flow FG may have been subjected to a pretreatment before entering the facility, for example through a scrubbing unit or a filtration unit.

The gas flow rich in nitrogen FN exiting the unit 2 of type at high pressure may contain, in addition to nitrogen, the least adsorbable constituents such as, where applicable, O2, Ar, NO.

The percentage of nitrogen in the flow rich in nitrogen FN is in particular between 50 and 90 vol %.

CO2 represents a portion, for example from 50 to 85 vol %, in the gas flow FCO2 rich in CO2.

In general, the compositions are given on a dry basis.

The feed gas flow FG arrives at the treatment unit 2, after having been compressed in the compression assembly 3, at a pressure within a range of 8 to 10 bar abs, and at a temperature close to ambient, for example between 5 and 45° C.

The gas flow rich in nitrogen FN is discharged from the treatment unit 2 at high pressure, in this case at a pressure of between 8 and 10 bar.

The facility 1 comprises an electric motor 20 having a rotational axle or shaft 21 secured to a main gear 22.

The facility 1 further comprises a pinion 23 driving a wheel of the compression stage 5 via a rotational axle or shaft 24.

Another pinion 25 in connection with the main gear 22 is arranged so as to transmit the rotational torque produced by the wheel of the expansion stage 8 of the turbine 6, via the rotational axle 26.

After compression, the feed gas flow FG is separated in the treatment unit 2. The gas flow rich in nitrogen FN, which is dry and pressurized, is heated in the thermal unit 10.

The expansion stage 8 transmits the energy, originating from the expansion to the low pressure of the hot and pressurized gas FN in the turbine 6, to the main gear 22 and thus to the compression assembly 3.

Thus, the energy required at the compression stage 5 is supplied partially by the motor 20 and partially by the expansion turbine 6. Such an arrangement can very significantly reduce, for example halve, the electrical energy consumed by the motor 20.

In the example described, the utilization device 4 comprises the compression stage 5 which is arranged so as to receive the mechanical energy delivered by the expansion stage 8, and the pinion 25 and the rotational axle 26 which ensure the transmission of the rotational torque.

Of course, various connections are possible between the wheels of the compression stage or stages and of the expansion stage or stages.

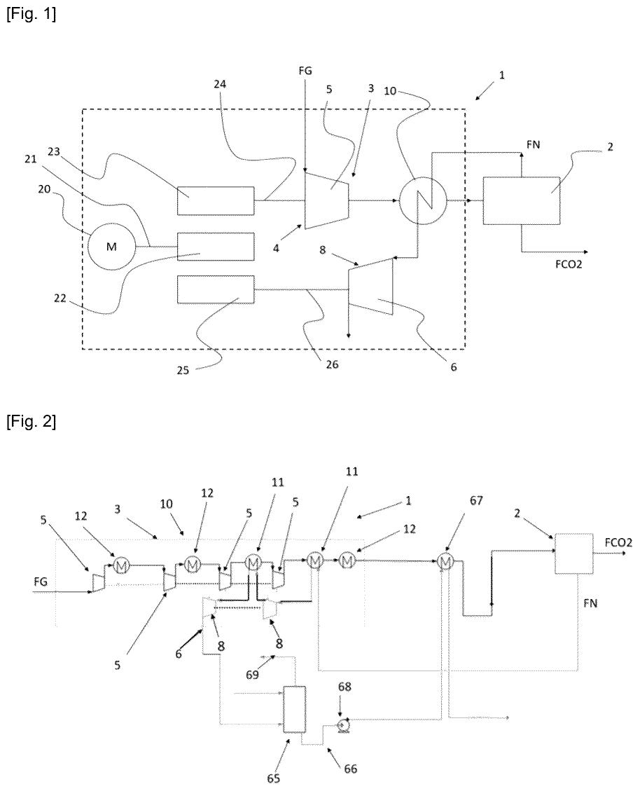

FIG. 2 illustrates an exemplary embodiment of the invention in the compression assembly 3 four compression stage stages 5 and the turbine 6 comprises two expansion stages 8.

These expansion stages 8, each provided with a wheel, are arranged in series in such a way that the gas flow rich in nitrogen FN first passes through one of the expansion stages 8 and then the other.

The expansion stages 8 transforming the energy from the gas flow rich in nitrogen FN may provide around 40% of the energy required for operating the compression stages.

In the example illustrated in FIG. 2, the thermal device 10 is arranged so as to allow transfers of heat between the gas flow rich in nitrogen FN and the feed gas flow FG.

The gas flow rich in nitrogen FN is for example at an ambient temperature, and the feed gas flow FG is at a higher temperature.

The invention thus makes it possible to take advantage of the gas flow rich in nitrogen FN, which is substantially at ambient temperature at the outlet of the PSA unit, in order to cool the feed gas flow FG so as to improve the overall thermodynamic performance of the facility 1.

The thermal device 10 comprises two gas/gas exchangers 11 in the compression assembly 3 which are arranged so as to allow a heat exchange between the gas flow rich in nitrogen FN and the feed gas flow FG, in order to heat the gas flow rich in nitrogen FN and cool the feed gas flow FG.

Each gas/gas heat exchanger 11 for exchanging heat between the gas flow rich in nitrogen FN and the feed gas flow FG is arranged at the outlet of one of the compression stages 5 such that the feed gas flow FG first passes through the compression stage 5 before passing through the heat exchanger 11.

The gas/gas exchanger 11 thus makes it possible to cool the feed gas flow FG which has undergone an increase in temperature due to the compression in the compression stage 5.

The two gas/gas exchangers 11 are arranged in series such that the gas flow rich in nitrogen FN first passes through one of these gas/gas exchangers 11 and then through the other of the gas/gas exchangers 11.

Each of the expansion stages 8 is provided downstream of each gas/gas heat exchanger 11 such that the gas flow rich in nitrogen FN first passes through the gas/gas heat exchanger 11 and then through the expansion stage 8 which is used to transmit mechanical torque to the dedicated compression stage 5.

The compression assembly 3 comprises three gas/heat transfer fluid heat exchangers 12 for exchanging heat between the feed gas flow FG and a cooling fluid other than the gas flow rich in nitrogen, this fluid being, in this case, glycol water belonging to a cooling circuit.

Each heat exchanger 11 or 12 is arranged at the outlet of one of the compression stages 5 such that the feed gas flow FG first passes through the compression stage 5 before passing through the heat exchanger 11 or 12.

In the example in FIG. 2, all of the compression stages 5 are followed by a heat exchanger, either of the gas/gas type 11 or of the gas/heat transfer fluid type 12. In the circulation direction of the feed gas flow FG, the two first compression stages 5, which are stages number 1 and number 2, are each followed by a gas/heat transfer fluid heat exchanger 12.

The two last stages 5 are each followed by a gas/gas heat exchanger 11.

Thus the gas flow rich in nitrogen FN serves to cool the feed gas flow FG at the outlet of two compression stages 5, which are stages number 3 and number 4.

The last gas/heat transfer fluid exchanger 12 is positioned downstream of the last gas/gas exchanger 11 so as to further cool the feed gas flow before it reaches the PSA treatment unit.

The gas flow rich in nitrogen is, for its part, heated via the exchangers 11 by the feed fluid FG.

Each turbine stage 8 is positioned downstream of one of the gas/gas exchangers 11.

The expansion stages 8 and the two gas/gas exchangers 11 are thus in series such that the gas flow rich in nitrogen FN passes successively through one of the gas/gas exchangers 11, then one of the expansion stages 8, then the other gas/gas exchanger 11 and lastly the other expansion stage 8.

The gas flow rich in nitrogen FN is substantially at atmospheric pressure when it exits the last turbine 6, and preferably at a temperature greater than −10° C., more preferably greater than 0° C.

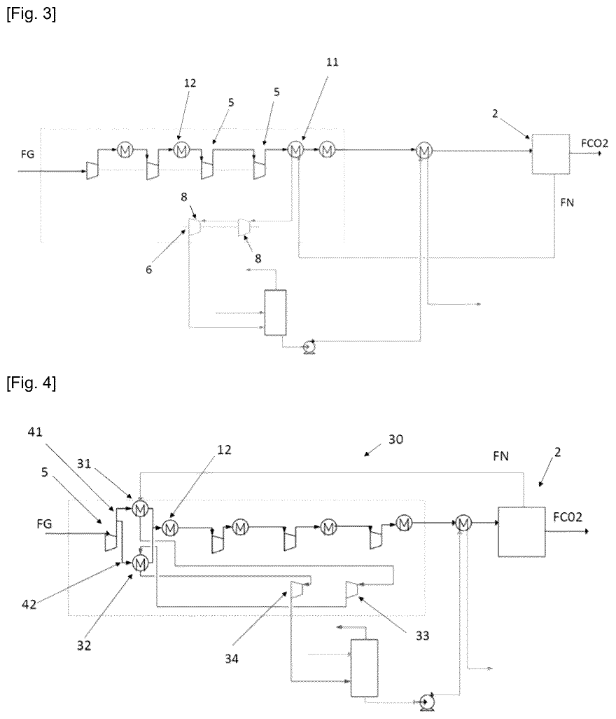

In a variant illustrated in FIG. 3, one of the compression stages 5 is connected directly to the following compression stage 5, without any heat exchanger 11 or 12 between these two compression stages 5. As in the example in FIG. 2, two expansion stages 8 are provided.

In the example in FIG. 3, a single gas/gas heat exchanger 11 is provided in the facility 1, this exchanger 11 being positioned downstream of the last of the four compression stages 5.

Thus the gas flow rich in nitrogen FN first passes through the heat exchanger 11 and then successively through the two turbines 6.

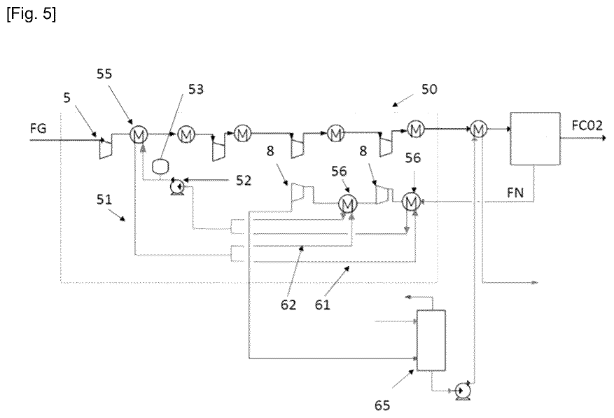

In the example illustrated in FIG. 4, the facility 30 comprises, for the gas flow rich in nitrogen FN, successively from the outlet of the treatment unit:
a first gas/gas heat exchanger 31,
a first expansion stage 33,
a second gas/gas heat exchanger 32,
a second expansion stage 34,
the first and second gas/gas heat exchangers 31 and 32 being positioned, for the feed gas flow FG, in parallel with one another and downstream of the first of the four compression stages 5.

Thus, in this example, the gas flow rich in nitrogen FN is used to cool the feed gas flow FG in the two exchangers 31 and 32 positioned in parallel, at the outlet of the first compression stage 5.

The feed gas flows FG subdivided into two branches 41 and 42 in the two exchangers 31 and 32 in parallel merge at the outlet of these two exchangers 31 and 32 so as to reform a single feed gas flow FG which passes through a gas/heat transfer fluid exchanger 12.

As can be seen, the feed gas flow FG sees the two gas/gas exchangers 31 and 32 as being in parallel, whilst the gas flow rich in nitrogen FN sees these two gas/gas exchangers 31 and 32 as being in series.

The compression stages 5 are arranged so as to bring the feed gas flow FG from a pressure slightly lower than atmospheric pressure to around 8 or 9 bar abs, which is the operating pressure of the PSA unit.

On a dry basis, the feed gas flow contains 22 mol % of CO2, 75 mol % of N2, 2 mol % of O2, 1 mol % of Ar and impurities at a few tens of ppm. The temperature is around 60° C., thus avoiding the condensation of liquid water.

The compression assembly 3 comprises an electric motor (not shown) actuating the four compression stages 5 in series. The expansion stages 8 of the turbine 6, which are also in series, supply a portion of the energy required for the compression in the compression assembly 3. In the present case, the wheels of the expansion stages 8 supply around 40% of this energy.

The gas expanded in the expansion stages 8 is the high-pressure flow coming from the PSA unit. It contains 94 mol % of N2, 3 mol % of CO2, 2 mol % of O2 and 1 mol % of Ar. This gas is available at around 8 bar abs and is expanded to a pressure slightly greater than atmospheric pressure. In order to increase the energy recoverable during the expansion, this flow is heated to a temperature of 70 to 80° C. before entering each of the expansion stages. The corresponding heat is recovered from the feed gas flow FG exiting the first compression stage 5.

The inter-stage pressures of the compression assembly 5 are of the order of 2 bar abs (outlet of stage 1), 3.5 bar abs (outlet of stage 2), and 5.5 bar abs (outlet of stage 3). The inter-stage pressure of expansion 8 is 3 bar abs. Equally, the outlet temperatures of the compression stages are respectively of the order of 140 to 150° C. (outlet of stage 1) and of 75 to 85° C. for the following stages. The exhaust temperatures of the expansion stages 8 are about 0° C.

The staging of the pressures, and more generally the operating conditions, are selected such that the wheels of a stage of the compression assembly and of the second expansion stage 8 have the same rotational speed. Thus, these two wheels may have the same rotational axle, for example on either side of a pinion.

This may likewise be the case as regards the first expansion stage and another compression stage.

At the thermal level, the feed gas flow exiting the first compression stage 5 is first cooled by exchange with the flow rich in nitrogen FN. These exchanges are effected by means of two gas-gas exchangers 31 and 32, which are U-shaped tube exchangers, in parallel in relation to the feed gas flow FG which is essentially divided in half between the two exchangers 31 and 32.

At the outlet of these exchangers 31 and 32, the feed gas flow is cooled to ambient temperature by refrigeration water, separated from condensation water, and is directed to the second compression stage 5. At the outlet of each stage 5, the feed gas flow is then cooled to ambient temperature by refrigeration water, separated from any condensation water.

It will be noted that the feed gas flow FG is used at the highest temperature in order to heat the intake of the expansion stages 8, and this makes it possible to increase the recoverable energy.

In the exemplary embodiment in FIG. 5, the facility 50 comprises an intermediate thermal circuit 51 using an intermediate heat transfer fluid different from the gas flow rich in nitrogen FN and from the feed gas flow FCO2, this intermediate circuit 51 being arranged so as to allow heat exchanges between the gas flow rich in nitrogen FN and the feed gas flow FCO2 by way of the intermediate heat transfer fluid.

This intermediate circuit 51 comprises a pump 52 for circulating the intermediate fluid. A temperature sensor 53 may be provided on this intermediate circuit 51.

The intermediate circuit 51 is arranged such that the intermediate heat transfer fluid passes through a gas/heat transfer fluid heat exchanger 55 arranged so as to allow exchanges of heat between the intermediate heat transfer fluid in the circuit 51 and the feed gas flow FG, and two other gas/heat transfer fluid heat exchangers 56 which are each positioned upstream of an expansion stage 8 such that the gas flow rich in nitrogen FN passes through this exchanger 56 so as to be heated by the intermediate heat transfer fluid in the circuit 51 before undergoing expansion in the expansion stages 8.

The gas/heat transfer fluid heat exchanger 55 for cooling the feed gas flow FG is positioned downstream of the first compression stage 5 such that the feed gas flow FG is cooled by the intermediate fluid at the outlet of this first compression stage 5.

The two exchangers 56 are positioned in parallel for the intermediate fluid such that the intermediate fluid is subdivided into two streams 61 and 62 each passing through one of these exchangers 56.

The gas flow rich in nitrogen FN sees, for its part, an arrangement in series of the exchangers 56 and of the expansion stages 8. Each expansion stage 8 is positioned downstream of one of the exchangers 56.

In the facilities which have just been described, provision is made of a unit 65 for producing ice-cold water using the dry nitrogen of the flow FN. The stream of ice-cold water 66 coming from the unit 65 is used in a heat exchanger 67 for further cooling the gas flow FG which enters the PSA unit. A pump 68 is provided for circulating the stream of ice-cold water. The flow FN is ultimately discharged into the atmosphere at the location 69.

The gas flow FCO2 rich in CO2 coming from the PSA unit can, where appropriate, undergo additional treatments, including, for example, complementary enrichment in CO2. The residual nitrogen thus extracted from the gas rich in CO2 can be recycled and participate in the expansion and in the recovery of energy.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-12. (canceled)

13. A facility for recovering carbon dioxide from a feed gas flow, the facility comprising:
a unit for treating the feed gas flow by pressure swing adsorption thereby producing, from the feed gas flow, a gas flow rich in carbon dioxide and a gas flow rich in nitrogen,
a compression assembly comprising at least one compression stage for compressing the feed gas flow before it enters the treatment unit,
a turbine comprising at least one expansion stage capable of delivering mechanical energy generated by the expansion of the gas flow rich in nitrogen in the expansion stage,
a thermal device configured to allow transfers of heat between the feed gas flow exiting a compression stage and the gas flow rich in nitrogen before expansion in the expansion stage, thereby heating the gas flow rich in nitrogen prior to expansion, and
a device for utilizing the mechanical energy delivered by the expansion stage.

14. The facility of claim 13, wherein the utilization device is an electric generator capable of utilizing the mechanical energy delivered by the expansion stage thereby producing electricity.

15. The facility of claim 13, wherein the utilization device comprises the compression stage which is configured to receive the mechanical energy delivered by the expansion stage.

16. The facility of claim 15, comprising at least two compression stages in the compression assembly and a turbine comprising at least two expansion stages actuatable by the gas flow rich in nitrogen, each expansion stage of the turbine being arranged so as to transmit mechanical energy to the compression assembly, the arrangement is irrespective of whether directly to one of the compression stages or to a rotational shaft common to several compression stages or to a shaft of a motor which actuates the compression stages.

17. The facility of claim 16, wherein these expansion stages are arranged in series in such a way that the gas flow rich in nitrogen first passes through one of the expansion stages and then the other.

18. The facility of claim 15, wherein the expansion stage or stages are dimensioned to provide at least 25% of the mechanical energy required for operating the compression stages.

19. The facility of claim 13, wherein the thermal device comprises at least one gas/gas heat exchanger arranged to allow transfers of heat between the feed gas flow exiting a compression stage and the gas flow rich in nitrogen before expansion in the expansion stage, thereby heating the gas flow rich in nitrogen prior to expansion.

20. The facility of claim 19, wherein the gas/gas heat exchanger is arranged at the outlet of the compression stage such that the feed gas flow first passes through the compression stage before passing through the heat exchanger.

21. The facility of claim 13, wherein the thermal device comprises one or more gas/heat transfer fluid heat exchangers for exchanging heat between the feed gas flow and a heat transfer fluid other than the gas flow rich in nitrogen, the fluid being glycol water belonging to a cooling circuit.

22. The facility of claim 20, wherein the facility comprises, for the gas flow rich in nitrogen, successively from the outlet of the treatment unit:
a first gas/gas heat exchanger,
a first expansion stage,
a second gas/gas heat exchanger,
a second expansion stage,
the first and second heat exchangers being positioned, for the feed gas flow, in parallel with one another and downstream of a compression stage.

23. The facility of claim 13, wherein the facility comprises an intermediate thermal circuit using an intermediate heat transfer fluid different from the gas flow rich in nitrogen and from the feed gas flow, the intermediate circuit being arranged to allow heat exchanges between the gas flow rich in nitrogen and the feed gas flow by way of the intermediate heat transfer fluid.

24. The facility of claim 13, wherein the gas flow rich in nitrogen produced from the wet feed gas flow is dried before expansion in the expansion stage, thereby containing less than 50 ppm of H20.
